(19) United States
(12) Patent Application Publication
(10) Pub. No.: US 2013/0246270 A1
(43) Pub. Date: Sep. 19, 2013

(54) Method and System for Multi-Modal Identity Recognition

(71) Applicant: O2 MICRO INC., Santa Clara, CA (US)

(72) Inventors: Sterling Shyundii Du, Shanghai (CN); Jingjing Zuo, Beijing (CN); Chengxia He, Sichuan (CN); Qi Zhu, Chengdu (CN)

(73) Assignee: O2 Micro Inc., Santa Clara, CA (US)

(21) Appl. No.: 13/790,543

(22) Filed: Mar. 8, 2013

(30) Foreign Application Priority Data
Mar. 15, 2012 (CN) 201210068792.7

(51) Int. Cl. G06K 9/00; G10L 17/00

(52) U.S. Cl. CPC G06K 9/00288; G10L 17/005
USPC 705/44; 382/118

(57) ABSTRACT

A device, a system and a method are provided for multi-modal identity recognition. The device includes a face recognition unit, a voice recognition unit, and a control unit. The face recognition unit is configured for generating a first recognition result by obtaining and processing face recognition information of a customer and by comparing the processed face recognition information with face recognition information stored in a facial feature database. The voice recognition unit is configured for generating a second recognition result by obtaining and processing voice recognition information of a customer and by comparing the processed voice recognition information with voice recognition information stored in an audio signature database. The control unit is configured for confirming an identity of the customer based on the first recognition result and the second recognition result.

### RELATED APPLICATIONS

This application claims priority to Chinese Patent Application Number 201210068792.7, filed on Mar. 15, 2012 with State Intellectual Property Office of P.R. China (SIPO), which is hereby incorporated by reference.

### BACKGROUND

1. Technical Field

The present disclosure relates to multi-modal identity recognition.

2. Background

Identity recognition is an emerging identification technology, which has many properties such as safe, reliable and accurate. Conventional identity recognition technologies include voice recognition, face recognition, fingerprint recognition, palmprint recognition, iris recognition, etc. In particular, for unclassified places such as an office, voice recognition or face recognition technology is usually adopted for identity recognition purposes.

Most of the identity recognition approaches utilizes a single modality for the underlying recognition tasks. For example, either voice or face usually is used alone for recognizing the identity of a person. Single modal based identity recognition often yields unsatisfactory or unstable recognition result. In addition, it is difficult to achieve robust face recognition due to variations in environment or appearances. Furthermore, face recognition in general is computationally expensive. There are different ways to capture facial images and depending on the specific modal adopted to capture a facial image, the captured image may include different types of information. For example, a grayscale camera is usually used to capture images that reflect the intensities of a picture without color. Although it is computationally less expensive to perform face recognition using grayscale images, to achieve reliable recognition performance, it demands high quality grayscale images, which requires good illumination. Since it often cannot be ensured to have good illumination, the qualities of grayscale images may vary greatly with the variation of environment, which often lead to errors and affect the result of face recognition. Accordingly, there exists a need to provide an improved system and method for recognizing identity more correctly and conveniently.

Because identity recognition is often applied in different applications, poor or unreliable recognition results directly impact the applications in which the identity recognition is plugged in. For example, although identity recognition technology may be applied in payment system, it is currently seldom used because of its unpredictable performance. This is one reason why existing payment systems still largely use cash payment, card payment (e.g., IC card, magnetic stripe card, and RF card), etc. Although current payment systems are convenient and safe, during the card payment, the customer is required to provide a card, enter a password, and sign his/her name, which are rather cumbersome. For example, if there are many customers queuing up for the payment, it may take a long time to complete payment. Besides, card payment is not quite secure. For example, a card may be lost and the password may be stolen or forgotten. Accordingly, there exists a need to provide an improved system and method for making payment based on identity in a more reliable manner.

### SUMMARY

The present disclosure describes methods and systems for achieving payment.

In one embodiment, an identity recognition device is provided. The identity recognition device includes a face recognition unit, a voice recognition unit, and a control unit. The face recognition unit is configured for generating a first recognition result by obtaining and processing face recognition information of a customer and by comparing the processed face recognition information with face recognition information stored in a facial feature database. The voice recognition unit is configured for generating a second recognition result by obtaining and processing voice recognition information of a customer and by comparing the processed voice recognition information with voice recognition information stored in an audio signature database. The control unit is configured for confirming an identity of the customer based on the first recognition result and the second recognition result.

In another embodiment, a payment system is provided. The payment system includes an identity recognition device including a face recognition unit, a voice recognition unit, and a control unit. The face recognition unit is configured for generating a first recognition result by obtaining and processing face recognition information of a customer and by comparing the processed face recognition information obtained with face recognition information stored in a facial feature database. The voice recognition unit is configured for generating a second recognition result by obtaining and processing voice recognition information of a customer and by comparing the processed voice recognition information with voice recognition information stored in an audio signature database. The control unit is configured for confirming an identity of the customer based on the first recognition result and the second recognition result, and further configured for associating the confirmed identity of the customer with a stored payment account of the customer to facilitate payment.

In yet another embodiment, an identity recognition method is provided. Face recognition information of a customer is obtained and processed. Then the processed face recognition information is compared with face recognition information stored in a facial feature database to generate a first recognition result. Voice recognition information of the customer is obtained and processed. Then the processed voice recognition information is compared with voice recognition information stored in an audio signature database to generate a second recognition result. An identity of the customer is confirmed based on the first recognition result and the second recognition result.

In still another embodiment, a payment method is provided. Face recognition information of a customer is obtained and processed. Then the processed face recognition information is compared with face recognition information stored in a facial feature database to generate a first recognition result. Voice recognition information of the customer is obtained and processed. Then the processed voice recognition information is compared with voice recognition information stored in an audio signature database to generate a second recognition result. An identity of the customer is confirmed based on the first recognition result and the second recognition result. Then the confirmed identity of the customer is associated with a stored payment account of the customer to facilitate payment.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating an example of an identity recognition device, in accordance with one embodiment of the present disclosure;

FIG. 2 is a block diagram illustrating an example of a face recognition unit of the identity recognition device, in accordance with one embodiment of the present disclosure;

FIG. 3 is a block diagram illustrating an example of a voice recognition unit of the identity recognition device, in accordance with one embodiment of the present disclosure;

FIG. 4 is a flow chart illustrating a method for recognizing identity, in accordance with one embodiment of the present disclosure;

FIG. 5 shows an example of an audio signature;

FIG. 6 is a block diagram illustrating an example of a payment system, in accordance with one embodiment of the present disclosure;

FIG. 7 is a flow chart illustrating a payment method, in accordance with one embodiment of the present disclosure;

FIG. 8 is a flow chart illustrating a method for registering for a card-free payment service, in accordance with one embodiment of the present disclosure; and

FIG. 9 is a flow chart illustrating a method for performing a card-free payment service, in accordance with one embodiment of the present disclosure.

### DETAILED DESCRIPTION

Reference will now be made in detail to the embodiments of the present disclosure, examples of which are illustrated in the accompanying drawings. While the present disclosure will be described in conjunction with the embodiments, it will be understood that they are not intended to limit the present disclosure to these embodiments. On the contrary, the present disclosure is intended to cover alternatives, modifications, and equivalents, which may be included within the spirit and scope of the present disclosure as defined by the appended claims.

Furthermore, in the following detailed description of embodiments of the present disclosure, numerous specific details are set forth in order to provide a thorough understanding of the present disclosure. However, it will be recognized by one of ordinary skill in the art that the present disclosure may be practiced without these specific details. In other instances, well-known methods, procedures, components, and circuits have not been described in detail as not to unnecessarily obscure aspects of the embodiments of the present disclosure.

The identity recognition device and method of the present disclosure can adopt voice recognition technology and/or face recognition technology. In one embodiment, both voice recognition technology and face recognition technology may be used to enhance the recognition accuracy.

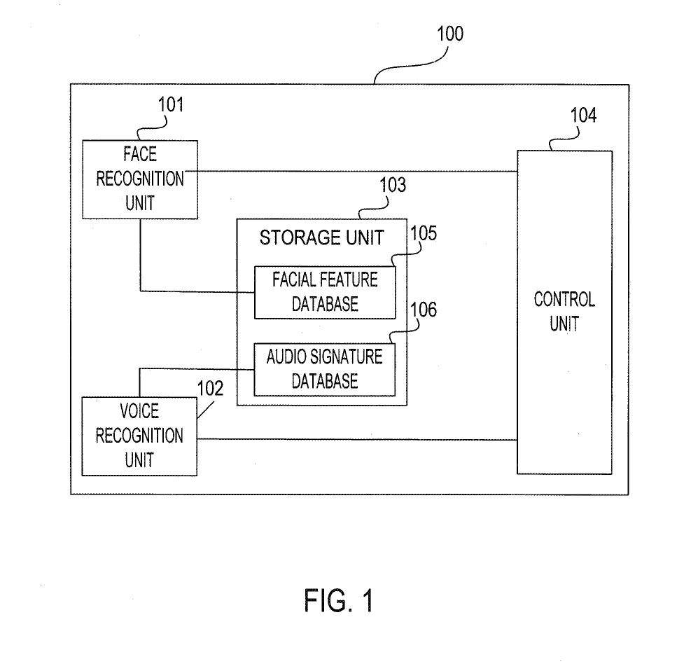

FIG. 1 is a block diagram illustrating an example of an identity recognition device 100, in accordance with one embodiment of the present disclosure. The identity recognition device 100 in this embodiment includes a face recognition unit 101, a voice recognition unit 102, a storage unit 103 and a control unit 104. The face recognition unit 101 may be configured for generating a first recognition result for a customer. The first recognition result may be generated by obtaining and processing face recognition information of the customer, and comparing the processed face recognition information with face recognition information stored in a facial feature database 105. The voice recognition unit 102 may be configured for generating a second recognition result for the customer. The second recognition result may be generated by obtaining and processing voice recognition information of the customer, and comparing the processed voice recognition information with voice recognition information stored in an audio signature database 106. The storage unit 103 in this embodiment includes the facial feature database 105 and the audio signature database 106, which may store image data and voice data respectively. The control unit 104 may be configured for confirming an identity of the customer based on the first recognition result generated by the face recognition unit 101 and the second recognition result generated by the voice recognition unit 102.

In accordance with an exemplary embodiment, the first recognition result can indicate whether the face recognition information matches the information of a certain customer stored in the facial feature database 105. The face recognition information may be obtained based on a facial image captured from the customer through a face recognition process. The second recognition result obtained by the voice recognition unit 102 can indicate whether the voice recognition information matches the information of a certain customer stored in the audio signature database 106. The voice recognition information may be obtained based on speech from the customer through a voice recognition process.

In one situation, if the matched customer information indicated by the first recognition result and the second recognition result belong to a same customer, the control unit 104 may confirm an identity of the same customer. Thus, the identity of the customer is successfully identified.

In another situation, if the first recognition result indicates that the face recognition information cannot match with any information stored in the facial feature database 105, which means the first recognition result indicates that it fails to recognize the face recognition information, and/or if the second recognition result indicates that the voice recognition information cannot match with any information stored in the audio signature database 106, which means the second recognition result indicates that it fails to recognize the voice recognition information, the control unit 104 may not confirm the identity of the customer. If so, the identity recognition device 100 can notify the customer to retry the face recognition process and/or the voice recognition process for completing the recognition of the customer identity.

In still another situation, if the matched customer information indicated by the first recognition result and the second recognition result belong to two different customers, the control unit 104 can indicate that it fails to confirm an identity of a customer. If so, the identity recognition device 100 can notify the customer to retry the face recognition process and/or the voice recognition process for completing the recognition of the customer identity.

As mentioned above, the identity recognition device 100 shown in FIG. 1 is only illustrated according to one embodiment of the present disclosure. In an alternative embodiment, the identity recognition device 100 can further include a switching unit (not shown) which is configured for controlling turning on and off of the face recognition unit 101 and the voice recognition unit 102. The identity recognition device 100 may be configured to include face recognition unit 101 and/or voice recognition unit 102 based on practical needs in various embodiments. It should be understood that various additions, modifications, and substitutions may be made to the identity recognition device 100 without departing from the spirit and scope of the principles of the present disclosure. For example, the identity recognition device 100 can include only one of the face recognition unit 101 and the voice recognition unit 102, without the other.

The present disclosure may utilize both voice recognition technology and/or face recognition technology to perform the identity recognition, for further enhancing the recognition accuracy.

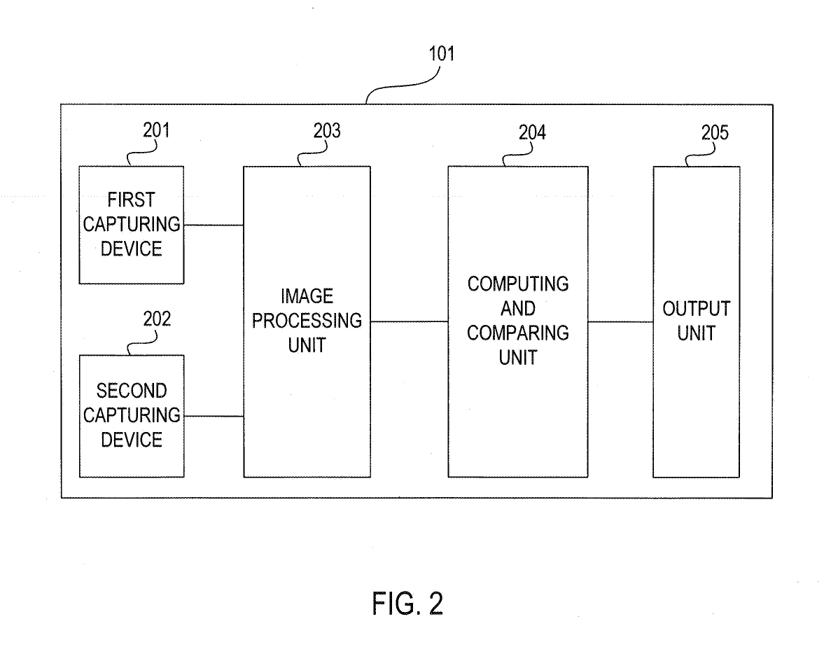

FIG. 2 is a block diagram illustrating an example of the face recognition unit 101 of the identity recognition device 100, e.g., as shown in FIG. 1, in accordance with one embodiment of the present disclosure. Elements labeled the same as in FIG. 1 have similar functions. In accordance with one embodiment, FIG. 2 is described in combination with FIG. 1.

In this embodiment, the face recognition unit 101 includes a first capturing device 201, a second capturing device 202, an image processing unit 203, a computing and comparing unit 204, and an output unit 205. Based on the first capturing device 201 and the second capturing device 202, the face recognition unit 101 can capture first face recognition information of a customer and second face recognition information of the customer, respectively. The image processing unit 203 may process the first and second face recognition information, based on the second face recognition information captured by the second camera device 202 and the first face recognition information captured by the first camera device 201. The first and second face recognition information may complement one another. It should be understood that the embodiment shown in FIG. 2 is by no means limiting and is an exemplary embodiment. For example, the face recognition unit 101 can only include a single capturing device (e.g., a grayscale camera).

In one embodiment, the first capturing device 201 can be a grayscale camera, so as to obtain a grayscale facial image of the customer. For example, the grayscale camera captures the grayscale image at a frequency of 2 to 3 frames per second. The second capturing device 202 can be an infrared camera, so as to obtain an infrared facial image of the customer. For example, the infrared camera captures the infrared image at a frequency of 2 to 3 frames per second. In the example of FIG. 2, the grayscale camera (i.e., the first capturing device 201) and the infrared camera (i.e., the second capturing device 202) work together to achieve a more accurate face recognition result. The grayscale facial image and the infrared facial image captured by those two cameras may be simultaneously sent to the image processing unit 203 for further processing.

The operations performed by the image processing unit 203 may include image enhancement operation and image conversion operation. More specifically, the image processing unit 203 may receive the grayscale facial image captured by the grayscale camera and the infrared facial image captured by the infrared camera, and may use the infrared facial image to enhance the grayscale facial image in order to obtain more accurate face recognition information. Then, the image processing unit 203 may convert the enhanced image, i.e., the image processing unit 203 may represent each point of the enhanced image in a digital format, so that the enhanced image is represented in form of a digital matrix. It should be understood that except for the above mentioned enhancement operation and conversion operation, the image processing unit 203 can perform other image processing, such as image compression, image restoration and image segmentation. By performing those operations, irrelevant images (e.g. irrelevant to face) and improper images can be filtered so that the valid face recognition information is obtained.

The computing and comparing unit 204 may receive the digital matrix converted by the image processing unit 203, and extract a feature matrix representing the face recognition information from the digital matrix converted by the image processing unit 203. The computing and comparing unit 204 may further compare the feature matrix with the information stored in the facial feature database 105 of the identity recognition device 100. For example, the information stored in the facial feature database 105 may include multiple facial feature matrices. Then, the computing and comparing unit 204 may compute a similarity value through a series of algorithms, and output the first recognition result (i.e., face recognition result) based on the similarity value. The output unit 205 coupled to the computing and comparing unit 204 may be configured to output the face recognition result.

The present disclosure may utilize image enhancement and/or correction technology. A result of a face recognition based solely on a grayscale image depends on illumination of visible light. For example, to achieve reliable recognition performance based on a grayscale image, good illumination is required. Since performance of an infrared image captured by the infrared camera does not rely on illumination of visible light, the identity recognition device 100 of the present disclosure may utilize the infrared facial image captured by the infrared camera to enhance the grayscale facial image captured by the grayscale camera, so as to achieve a more accurate result of face recognition.

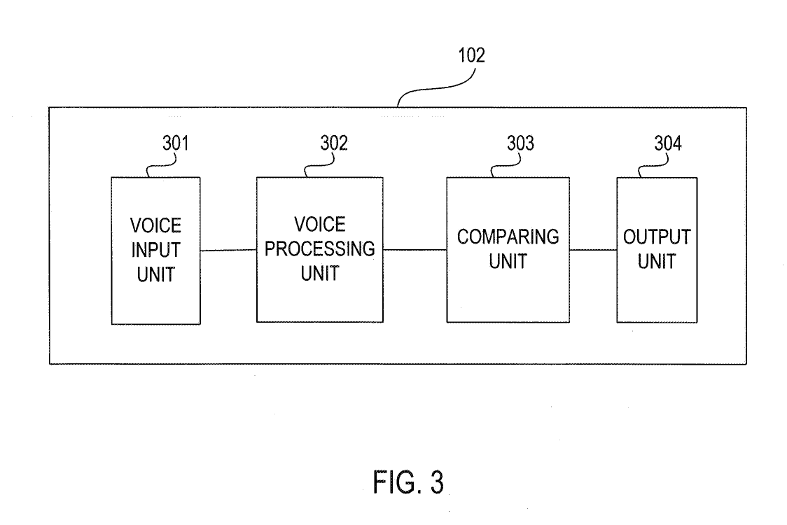

FIG. 3 is a block diagram illustrating an example of a voice recognition unit 102 of the identity recognition device 100, e.g., as shown in FIG. 1, in accordance with one embodiment of the present disclosure. Elements labeled the same as in FIG. 1 have similar functions. In accordance with one embodiment, FIG. 3 is described in combination with FIG. 1. As shown in FIG. 3, the voice recognition unit 102 may include a voice input unit 301, a voice processing unit 302, a comparing unit 303, and an output unit 304.

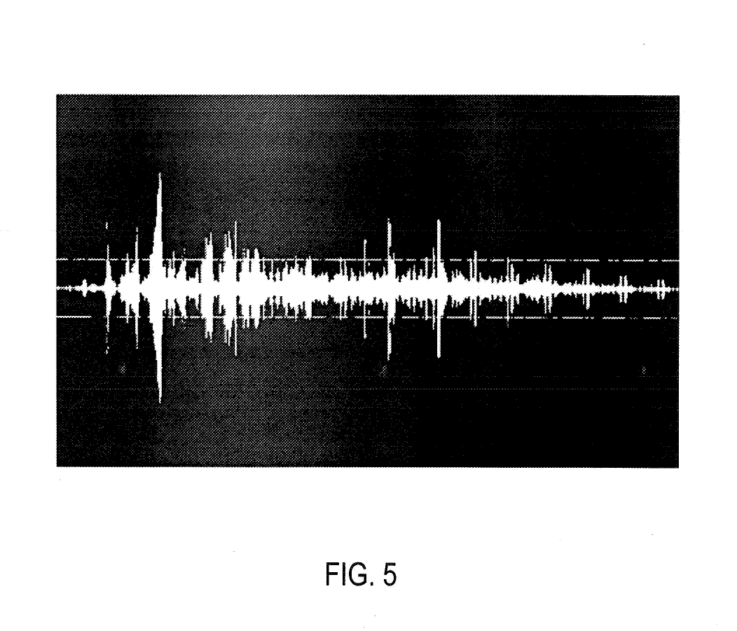

The voice input unit 301 may be a microphone, configured to capture the voice recognition information of the customer. The voice processing unit 302 may receive and process the voice recognition information captured by the voice input unit 301. The voice processing unit 302 may include an audio signature extraction module (not shown in FIG. 3). The voices of different persons have different audio signatures. FIG. 5 shows an example of an audio signature. The audio signature extraction module (not shown in FIG. 3) in the voice processing unit 302 may extract frequency and amplitude from the captured voice recognition information. Then the voice processing unit 302 may determine the tone by e.g., the frequency, volume by e.g., the amplitude and other information including e.g., timbre. After being processed by the voice processing unit 302, the above-mentioned information may be converted into text format. The voice processing unit 302 may extract one or more key words from the information text, so as to generate the processed voice recognition information of the customer.

The comparing unit 303 may compare the processed voice recognition information with the information stored in the audio signature database 106 of the identity recognition device 100. Then, for example, the comparing unit 303 may determine that the voice recognition information belongs to whom and what is the content of the voice recognition information, so as to obtain the second recognition result (i.e., voice recognition result). The output unit 304 coupled to the comparing unit 303 may be configured to output the voice recognition result.

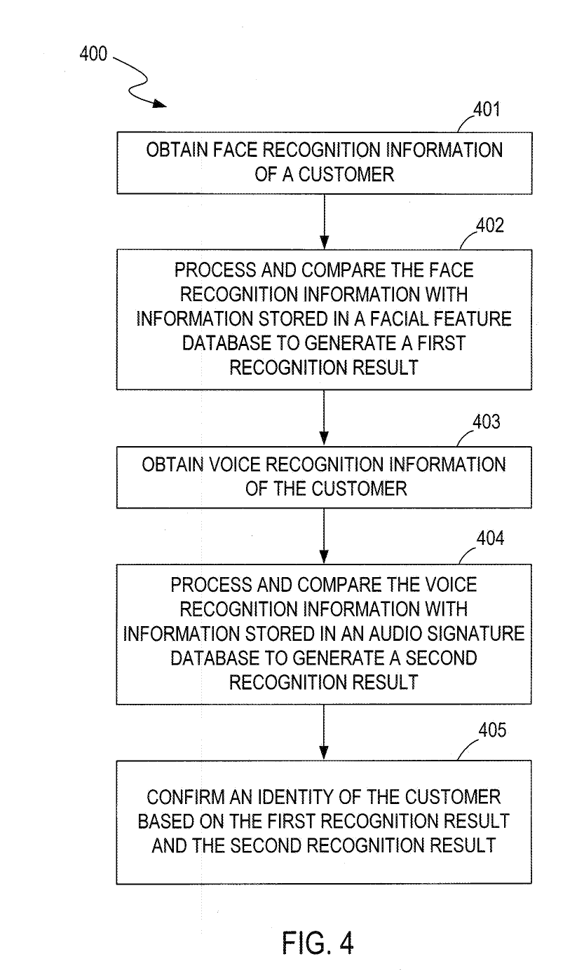

FIG. 4 is a flow chart illustrating an example of a method 400 for recognizing identity, in accordance with one embodiment of the present disclosure. In accordance with one embodiment, FIG. 4 is described in combination with FIG. 1-FIG. 3.

In this embodiment, at 401, face recognition information of a customer is obtained. As mentioned above, the face recognition unit 101 may utilize a grayscale camera and an infrared camera to capture the face recognition information. In a normal scenario, the grayscale camera and the infrared camera may capture images at a frequency of 2 to 3 frames per second.

At 402, a first recognition result may be generated by processing the captured face recognition information and comparing the processed face recognition information with customer information stored, e.g., in the facial feature database 105, so as to generate a first recognition result. The operations performed by the face recognition unit 101 may mainly include image enhancement operation and image conversion operation. During the image enhancement operation, the face recognition unit 101 can use an infrared facial image captured by the infrared camera to enhance a grayscale facial image captured by the grayscale camera in order to obtain more accurate face recognition information, and to decrease or eliminate the dependence on the illumination condition. During the image conversion operation, the face recognition unit 101 can convert the enhanced facial image into a digital matrix, and further extract a feature matrix representing the face recognition information through a series of algorithms. Then, the face recognition unit 101 may compare the feature matrix with multiple facial feature matrices stored in the facial feature database 105 to compute a similarity value between them. Thus, the first recognition result (i.e., face recognition result) is generated.

At 403, voice recognition information of the customer is obtained. The voice recognition unit 102 can utilize a voice input unit such as a microphone to capture the voice recognition information.

At 404, a second recognition result is generated by processing the captured voice recognition information, and comparing the processed voice recognition information with information stored in an audio signature database 106. For example, the voice recognition unit 102 can extract frequency and amplitude from the obtained voice recognition information, so as to obtain tone, volume and timbre of the customer. Then, the above-mentioned information may be converted into text format. The voice recognition unit 102 may extract one or more key words from the information text, so as to produce the processed voice recognition information of the customer. The voice recognition unit 102 may compare the processed voice recognition information with information stored in the audio signature database 106. Thus, the voice recognition unit 102 determines that the voice recognition information belongs to whom and what is the content of the voice recognition information, so as to generate the second recognition result (i.e., voice recognition result).

At 405, an identity of the customer is confirmed based on the first recognition result and the second recognition result.

As mentioned above, the present disclosure can utilize face recognition technology alone, or utilize both face recognition technology and voice recognition technology. Therefore, in one embodiment, 403 and 404 can be omitted if only face recognition is utilized. In addition, the sequence of obtaining voice recognition information and face recognition information is by no means limiting. For example, besides the sequence shown in FIG. 4, the face recognition information can be captured after the voice recognition information, or the face recognition information and the voice recognition information can be captured simultaneously. Furthermore, processing the face recognition information can be performed after obtaining the voice recognition information. The present disclosure can apply to other suitable procedure or modified steps of FIG. 4.

Identity recognition in accordance with various embodiments of the present disclosure may be applied in different applications. For example, a payment system and a payment method are provided below based on the identity recognition disclosed above.

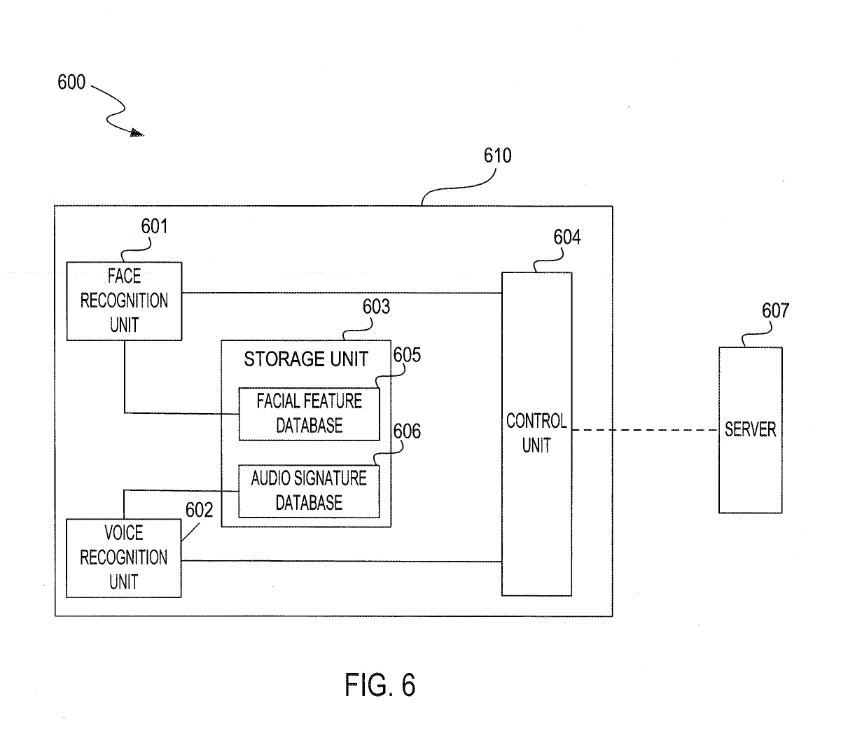

FIG. 6 is a block diagram illustrating an example of a payment system 600, in accordance with one embodiment of the present disclosure. The identity recognition technology of the present disclosure can facilitate a card-free payment service.

As shown in FIG. 6, the payment system 600 may include an identity recognition device 610. The identity recognition device 610 may include a face recognition unit 601, a voice recognition unit 602, a storage unit 603 and a control unit 604. In FIG. 6, elements 601-606 have similar functions with elements 101-106 in FIG. 1-FIG. 3. In accordance with one embodiment, FIG. 6 is described in combination with FIG. 1-FIG. 4. Like the control unit 104 in FIG. 1, the control unit 604 may recognize an identity of a customer based on a first recognition result generated by the face recognition unit 601 and a second recognition result generated by the voice recognition unit 602. In addition, the control unit 604 may be further configured for associating the recognized identity of the customer with a stored payment account of the customer based on the identity recognition result, so as to facilitate payment.

More specifically, the face recognition unit 601 may be configured to capture and process face recognition information of the customer and to compare the processed face recognition information with information stored in a facial feature database 605, so as to generate a first recognition result. The voice recognition unit 602 may be configured to capture and process voice recognition information of the customer, and to compare the processed voice recognition information with information stored in an audio signature database 606, so as to generate a second recognition result. The storage unit 603 may include the facial feature database 605 and the audio signature database 606, which are used to store image data and voice data respectively. The control unit 604 may be configured to confirm the identity of the customer based on the first recognition result and the second recognition result. Then the control unit 604 may associate the confirmed identity of the customer with the stored payment account of the customer based on the identity recognition result, so as to facilitate payment.

In one embodiment, the payment system 600 may further include a server 607, configured for storing identity information of one or more customers and associated payment accounts of the one or more customers. The control unit 604 may communicate with the server 607 over a network (e.g., Internet).

The payment system of the present disclosure can utilize both voice recognition technology and face recognition technology to confirm the identity of the customer. Therefore, the identity recognition accuracy may be further enhanced, and customers can achieve secure and quick payment services based on the payment system of the present disclosure without carrying cards.

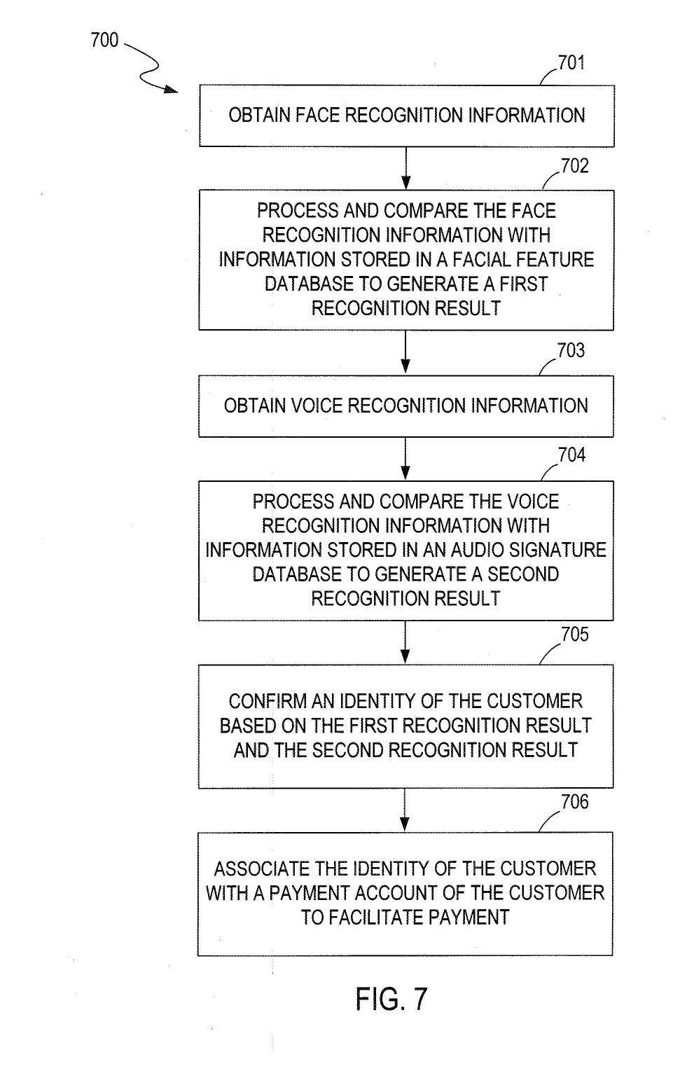

FIG. 7 is a flow chart illustrating a payment method 700, in accordance with one embodiment of the present disclosure. In accordance with one embodiment, FIG. 7 is described in combination with FIG. 6.

At 701, face recognition information of a customer is obtained. As mentioned above, the face recognition unit 601 uses a grayscale camera and an infrared camera to capture the face recognition information. For example, the grayscale camera and the infrared camera may capture images at a frequency of 2 to 3 frames per second.

At 702, a first recognition result may be generated by processing the obtained face recognition information and comparing the processed face recognition information with customer information stored, e.g., in the facial feature database 605. The operations performed by the face recognition unit 601 can include image enhancement operation and image conversion operation. During the image enhancement operation, the face recognition unit 601 may use an infrared image captured by an infrared camera to enhance a grayscale image captured by a grayscale camera in order to obtain more accurate face recognition information and decrease or eliminate the dependence on the illumination condition. During the image conversion operation, the face recognition unit 601 may convert the enhanced facial image into a digital matrix, and further extract a feature matrix representing the face recognition information through a series of algorithms. Then, the face recognition unit 601 may compare the feature matrix with multiple facial feature matrices stored in the facial feature database 105 to compute a similarity value between them. Thus, the first recognition result (i.e., the face recognition result) is generated.

At 703, voice recognition information of the customer is obtained. The voice recognition unit 602 can utilize a voice input unit such as a microphone to capture the voice recognition information.

At 704, a second recognition result is generated by processing the obtained voice recognition information, and comparing the processed voice recognition information with information stored in an audio signature database 606. For example, the voice recognition unit 602 can extract frequency and amplitude from the obtained voice recognition information, so as to obtain tone, volume and timbre of the customer. Then, the above-mentioned information may be converted into text format. The voice recognition unit 602 may extract one or more key words from the information text, so as to produce the processed voice recognition information of the customer. The voice recognition unit 602 may compare the processed voice recognition information with the information stored in the audio signature database 606. Thus, the voice recognition unit 602 may determine that the voice recognition information belongs to whom and what is the content of the voice recognition information so as to generate the second recognition result (i.e., the voice recognition result).

At 705, an identity of the customer is confirmed based on the first recognition result and the second recognition result.

At 706, the confirmed identity of the customer is associated with a stored payment account of the customer based on the identity recognition result, so as to facilitate payment.

The present disclosure can apply to other suitable procedure or modified steps of FIG. 7.

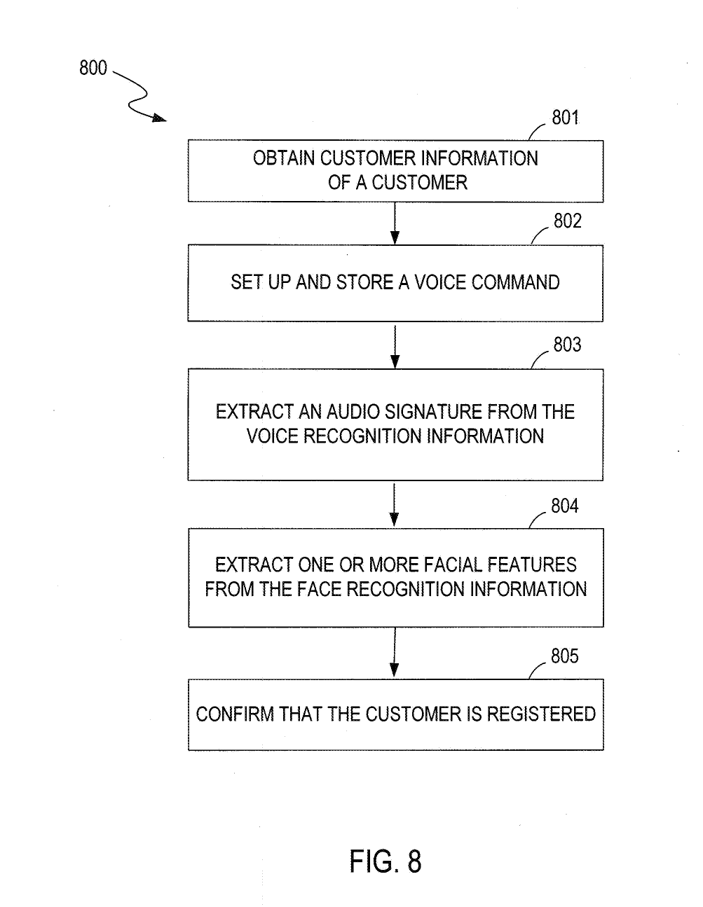

Further, in order to use a card-free payment service, a customer may first register for this service. FIG. 8 is a flow chart illustrating a method 800 for registering for a card-free payment service, in accordance with one embodiment of the present disclosure. In accordance with one embodiment, FIG. 8 is described in combination with FIG. 6 and FIG. 7.

As shown in FIG. 8, if a customer wants to conduct a card-free payment, he/she may first submit a request for the card-free payment service. At 801, customer information of the customer may be obtained by a payment system (e.g., the payment system 600). The customer information may include payment account, authorization information, voice recognition information, and face recognition information. Then at 802, a voice command may be set up for the customer and stored, e.g., in the payment system. At 803, an audio signature may be extracted from the voice recognition information. Then at 804, one or more facial features may be extracted from the face recognition information. At 805, the payment system may confirm that the customer is registered.

In one embodiment, the customer information, the audio signature, the voice command and the one or more facial features may be stored in the server 607.

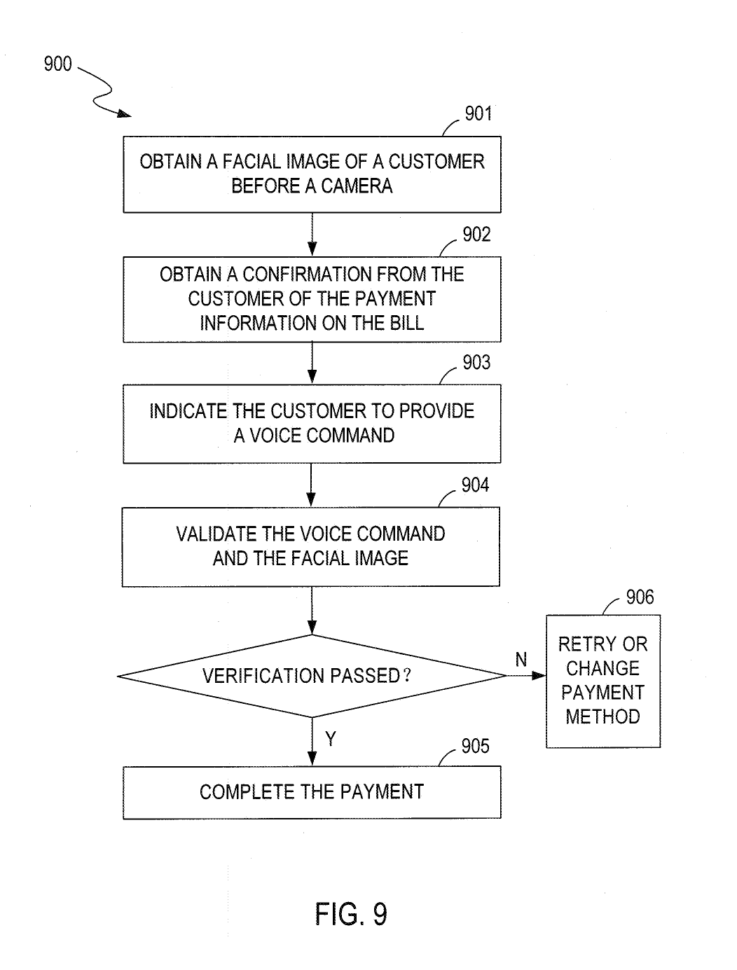

FIG. 9 is a flow chart illustrating a method 900 for performing a card-free payment service, in accordance with one embodiment of the present disclosure. In accordance with one embodiment, FIG. 9 is described in combination with FIG. 6 and FIG. 8, for a customer using the payment system of the present disclosure to conduct a payment. At 901, a facial image of the customer may be obtained, when e.g., the customer is before a camera in the payment system and near a check-out counter (e.g., a Point of Sale machine). Then at 902, the customer may confirm payment information on the bill.

At 903, the payment system may indicate the customer to provide a voice command. For example, the customer may hear an indication voice from the payment system, and speak the voice command he/she set up before to perform the voice recognition. Then at 904, the payment system validates the voice command and the facial image from the customer. If the verification is successful, the payment system completes the payment with a stored payment account at 905. The payment account is associated with a recognized identity of the customer based on the verification. If the verification is failed, the payment system can notify the customer to retry the face recognition and/or voice recognition or to change to another payment method.

The above-mentioned embodiments may use one or more electric components. Those electric components typically involve processors or controllers, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by the processor, cause the processor to perform at least a portion of the methods described herein. The above examples are exemplary only, and thus are not intended to limit in any way the definition and/or meaning of the term “processor”.

The above-mentioned embodiments may use one or more non-transitory computer readable medium containing computer executable instructions. Such instructions, when executed by the processor, cause the processor to perform the following steps: receive a first signal indicative of face recognition information from an input device; process the first signal, and compare the processed first signal with information stored in a facial feature database, so as to generate a first recognition result; receive a second signal indicative of voice recognition information from the input device; process the second signal, and compare the processed second signal with information stored in an audio signature database, so as to generate a second recognition result; recognize an identity of the customer based on the first recognition result and the second recognition result; associate the recognized identity of the customer with a payment account; and utilizes the payment account to achieve payment for the customer based on the recognized identity of the customer and the associated payment account.

Furthermore, in the one or more computer readable mediums, the computer executable instructions can cause the processor not to perform payment procedures, but only determine the identity information according to the first recognition result and the second recognition result.

In the one or more computer readable mediums, at least part of the computer executable instructions include taking the face recognition information captured by the first camera device and the second camera device as the first signal, wherein the first camera device is a grayscale camera and the second camera device is an infrared camera.

In the one or more computer readable mediums, at least part of the computer executable instructions include using the infrared image captured by the infrared camera to enhance the grayscale image captured by the grayscale camera, and taking the enhanced image as the first signal.

In the one or more computer readable mediums, at least part of the computer executable instructions include taking the voice recognition information captured by a microphone as the second signal.

The payment system of the present disclosure can utilize both voice recognition technology and face recognition technology to confirm the identity information of the customer. Therefore, the identity recognition accuracy is further enhanced, and the customers can achieve secure and quick payment without carrying cards.

While the foregoing description and drawings represent embodiments of the present disclosure, it will be understood that various additions, modifications, and substitutions may be made therein without departing from the spirit and scope of the principles of the present disclosure as defined in the accompanying claims. One skilled in the art will appreciate that the present disclosure may be used with many modifications of form, structure, arrangement, proportions, materials, elements, and components and otherwise, used in the practice of the disclosure, which are particularly adapted to specific environments and operative requirements without departing from the principles of the present disclosure. The presently disclosed embodiments are therefore to be considered in all respects as illustrative and not restrictive, the scope of the present disclosure being indicated by the appended claims and their legal equivalents, and not limited to the foregoing description.

We claim:

1. An identity recognition device, comprising:
a face recognition unit, configured for generating a first recognition result by obtaining and processing face recognition information of a customer and by comparing the processed face recognition information with face recognition information stored in a facial feature database;
a voice recognition unit, configured for generating a second recognition result by obtaining and processing voice recognition information of a customer and by comparing the processed voice recognition information with voice recognition information stored in an audio signature database; and
a control unit, configured for confirming an identity of the customer based on the first recognition result and the second recognition result.

2. The identity recognition device of claim 1, wherein
the processed face recognition information comprises first face recognition information and second face recognition information;
the face recognition unit obtains the first face recognition information and the second face recognition information based on a first facial image from a first capturing device and a second facial image from a second capturing device respectively; and
the second face recognition information and the first face recognition information complement one another.

3. The identity recognition device of claim 2, wherein
the first capturing device is a grayscale camera; and
the second capturing device is an infrared camera.

4. The identity recognition device of claim 1, further comprising a storage unit coupled to the face recognition unit and the voice recognition unit,
wherein the storage unit comprises the facial feature database and the audio signature database.

5. A payment system comprising an identity recognition device that comprises:
a face recognition unit, configured for generating a first recognition result by obtaining and processing face recognition information of a customer and by comparing the processed face recognition information obtained with face recognition information stored in a facial feature database;
a voice recognition unit, configured for generating a second recognition result by obtaining and processing voice recognition information of a customer and by comparing the processed voice recognition information with voice recognition information stored in an audio signature database; and
a control unit, configured for confirming an identity of the customer based on the first recognition result and the second recognition result, and further configured for associating the confirmed identity of the customer with a stored payment account of the customer to facilitate payment.

6. The payment system of claim 5, further comprising a server configured for storing the payment account of the customer.

7. The payment system of claim 5, wherein
the processed face recognition information comprises first face recognition information and second face recognition information;
the face recognition unit obtains the first face recognition information and the second face recognition information based on a first facial image from a first capturing device and a second facial image from a second capturing device respectively; and
the second face recognition information and the first face recognition information complement one another.

8. The payment system of claim 7, wherein
the first capturing device is a grayscale camera and the first facial image is a grayscale facial image; and
the second capturing device is an infrared camera and the second facial image is an infrared facial image.

9. The payment system of claim 8, wherein the infrared facial image is utilized to enhance the grayscale facial image.

10. The payment system of claim 5, further comprising a storage unit coupled to the face recognition unit and the voice recognition unit,
wherein the storage unit comprises the facial feature database and the audio signature database.

11. An identity recognition method, comprising:
obtaining face recognition information of a customer;
processing the face recognition information;
comparing the processed face recognition information with face recognition information stored in a facial feature database to generate a first recognition result;
obtaining voice recognition information of the customer;
processing the voice recognition information;
comparing the processed voice recognition information with voice recognition information stored in an audio signature database to generate a second recognition result; and
confirming an identity of the customer based on the first recognition result and the second recognition result.

12. The identity recognition method of claim 11, wherein obtaining face recognition information of the customer comprises:
obtaining first face recognition information based on a first facial image from a first capturing device; and
obtaining second face recognition information based on a second facial image from a second capturing device, wherein the second face recognition information and the first face recognition information complement one another.

13. The identity recognition method of claim 12, wherein
the first capturing device is a grayscale camera, and
the second capturing device is an infrared camera.

14. The identity recognition method of claim 11, wherein the voice recognition information is obtained from a microphone.

15. A payment method comprising:
obtaining face recognition information of a customer;
processing the face recognition information;
comparing the processed face recognition information with face recognition information stored in a facial feature database to generate a first recognition result;
obtaining voice recognition information of the customer;
processing the voice recognition information;
comparing the processed voice recognition information with voice recognition information stored in an audio signature database to generate a second recognition result;
confirming an identity of the customer based on the first recognition result and the second recognition result; and
associating the confirmed identity of the customer with a stored payment account of the customer to facilitate payment.

16. The payment method of claim 15, further comprising the following steps for registering the customer:
obtaining and storing customer information of the customer, wherein the customer information comprises payment account, authorization information, voice recognition information, and face recognition information;
setting up a voice command for the customer;
extracting and storing an audio signature from the voice recognition information of the customer;
extracting and storing a facial feature from the face recognition information of the customer; and
confirming that the customer is registered.

17. The payment method of claim 15, wherein obtaining face recognition information of the customer comprises:
obtaining first face recognition information based on a first facial image from a first capturing device; and
obtaining second face recognition information based on a second facial image from a second capturing device, wherein the second face recognition information and the first face recognition information complement one another.

18. The payment method of claim 17, wherein
the first capturing device is a grayscale camera and the first facial image is a grayscale facial image; and
the second capturing device is an infrared camera and the second facial image is an infrared facial image.

19. The payment method of claim 18, wherein the infrared facial image is utilized to enhance the grayscale facial image.

20. The payment method of claim 15, wherein the voice recognition information is obtained from a microphone.
